(19) United States
(12) Patent Application Publication
(10) Pub. No.: US 2024/0295429 A1
(43) Pub. Date: Sep. 5, 2024

(54) BREW ASSIST SCALE

(71) Applicant: Fellow Industries, Inc., San Francisco, CA (US)

(72) Inventor: Jacob Alan Miller, San Francisco, CA (US)

(21) Appl. No.: 18/592,878

(22) Filed: Mar. 1, 2024

Related U.S. Application Data
(60) Provisional application No. 63/449,951, filed on Mar. 3, 2023.

(51) Int. Cl. G01G 17/04; A23F 5/26; A47J 31/02; A47J 31/44; G01G 23/36

(52) U.S. Cl. CPC G01G 17/04; A23F 5/26; A47J 31/02; A47J 31/4403; G01G 23/361

(57) ABSTRACT

An apparatus configured to assist with beverage preparation can include a main body having an outer housing, a weigh pan coupled to the main body, one or more user input components and a display component disposed at the outer housing, and a processor disposed within the main body. The weigh pan can support beverage components to be weighed, the user input components can accept user inputs regarding desired settings for beverage preparation, and the display component can display outputs regarding weights detected on the weigh pan The processor can facilitate automatically detecting the weight of ground coffee placed atop the weigh pan, determining a water target weight based on the detected ground coffee weight and a water ratio setting, detecting the water target weight being reached while water is being poured over the ground coffee, and providing output to a user when the water target weight is reached.

### CROSS-REFERENCE TO RELATED APPLICATIONS

This application claims the benefit of priority of U.S. Provisional Application No. 63/449,951, filed on Mar. 3, 2023, and titled “BREW ASSIST SCALE,” which is hereby incorporated by reference in its entirety.

### TECHNICAL FIELD

The present disclosure relates generally to weigh scales, and more particularly to weigh scales for beverage preparation.

### BACKGROUND

Coffee aficionados currently have many ways of procuring high quality coffee to meet their consumption desires. One form of home brewed or otherwise handcrafted coffee involves pour over brewing where a user can pour water over ground or powdered coffee and through a filter to result in a finished drinkable coffee product. Pour over coffee preparation is popular with many aficionados, as this can allow a user to brew coffee manually according to a variety of recipes and specifications with respect to grind types, sizes, water ratios, temperatures, and other variable factors. To achieve a particular recipe or user preference, manually weighing out both the amount of coffee grounds and water to be poured over are common procedures.

Unfortunately, weigh scales used for brewing handcrafted pour over coffee and preparing other beverages have traditionally been limited in nature. While a typical scale may be readily usable to provide an exact weight for coffee grounds to be used, a user then typically needs to calculate the amount of water needed based on their preferred coffee to water ratio, remove the coffee from the scale, and then precisely measure the calculated amount of water needed. This can often be cumbersome and error prone for manual pour over coffee preparation.

Although traditional weigh scales for coffee and beverage use have worked in the past, improvements are always helpful. In particular, what is desired are improved weigh scales that assist a user in the streamlined manual preparation of coffee and other beverages.

### SUMMARY

It is an advantage of the present disclosure to provide improved weigh scales that assist a user in the streamlined manual preparation of coffee and other beverages. The disclosed weigh scales allow for improved user assistance in manually preparing pour over coffee, among other possible applications. These advantages can be accomplished at least in part by utilizing an intelligent brew assist scale configured to facilitate various automatically performed processes to assist the user. Such automatically performed processes can include detecting ground coffee weights placed atop the scale, determining target water weights to be poured over the ground coffee based on the detected ground coffee weights and other variable user preferences, detecting the increased weights of water poured over the ground coffee, and providing outputs to the user regarding detected ground coffee weights, determined target water weights, dynamically changing water weights during pour over brewing processes, and reaching target water weights.

In various embodiments of the present disclosure, an apparatus configured to assist with beverage preparation can include a main body, a weigh pan, one or more user input components, a display component, and a processor. The main body can have an outer housing and one or more internal components contained therein. The weigh pan can be coupled to the main body and can be configured to support beverage components to be weighed thereupon. The one or more input components can be disposed at the outer housing and can be configured to accept user inputs regarding desired settings for beverage preparation. The display component can be disposed at the outer housing and can be configured to display outputs regarding weights detected on the weigh pan. The processor can be disposed within the main body and can be coupled to the one or more user inputs and the display component. The processor can be configured to facilitate various operations, including detecting automatically the weight of ground coffee placed atop the weigh pan, determining automatically a water target weight based on the detected ground coffee weight and a water ratio setting, detecting automatically the water target weight being reached while water is being poured over the ground coffee, and providing automatically output to a user when the water target weight is reached.

In various detailed embodiments, the one or more user input components can include a power and tare button, a mode select button, and a timer control button. The power and tare button can also include a dial component configured to accept user input for different settings, which can include settings for measurement units and water to coffee ratios. The apparatus can also include a battery disposed within the main body and coupled to the processor, as well as a charging port disposed at the outer housing and coupled to the battery. The charging port can be configured to facilitate charging the battery from an external power source. In various arrangements, the processor can be further configured to facilitate providing automatically output to the user on the display component reflecting the determined water target weight, detecting automatically the changing weight of the water poured over the ground coffee as the water is being poured over the ground coffee, and providing automatically output to the user on the display component reflecting the changing weight of the water. The processor can further be configured to detect the changing weight of the water and provide output reflecting the changing weight of the water dynamically and continuously as the water is being poured over the ground coffee. The processor can also be configured to perform some or all steps automatically without user input after the weight of the ground coffee is detected. In some detailed arrangements, the output when the water target weight is reached can be automatically provided on the display component. In addition, the processor can be further configured to facilitate accepting automatically a user input at one of the user input components regarding a timer, and providing automatically a timer output at the display component regarding a dynamically changing timer. The processor can also be configured to start the dynamically changing timer based on a user input or based on the detection of water weight first being added.

In various further embodiments of the present disclosure, a brew assist scale configured to assist with the manual preparation of pour over coffee by a user can include a main body, a weigh pan, a power and tare button, a mode select button, a timer control button, a digital display, and a processor. The main body can have an outer housing and one or more internal components contained therein. The weigh pan can be coupled to the main body and can be configured to support pour over coffee brewing components as well as coffee and water to be weighed thereupon. The power and tare button can be disposed at the outer housing and can be configured to accept user inputs regarding powering the brew assist scale and taring a weight detected on the weigh pan. The mode select button can be disposed at the outer housing and can be configured to accept user input regarding a mode of operation of the brew assist scale. The timer control button can be disposed at the outer housing and can be configured to accept user input regarding the operation of a timer associated with a manual pour over coffee preparation process. The digital display component can be disposed at the outer housing and can be configured to display outputs regarding mode selection, timer operation, and weights detected on the weigh pan during the manual pour over coffee preparation process. The processor can be disposed within the main body and can be coupled to the power and tare button, the mode select button, the timer control button, and the display component. The processor can be configured to facilitate various operations, including detecting automatically the weight of ground coffee placed atop the weigh pan, determining automatically a water target weight based on the detected ground coffee weight and a water to coffee ratio setting, providing automatically output to the user on the digital display component reflecting the determined water target weight, detecting automatically the changing weight of the water poured over the ground coffee as the water is being poured over the ground coffee during the manual pour over coffee preparation process, providing automatically output to the user on the digital display component reflecting the changing weight of the water, detecting automatically the water target weight being reached while water is being poured over the ground coffee during the manual pour over coffee preparation process, and providing automatically output to the user on the digital display component when the water target weight is reached.

In various detailed embodiments, the determined water target weight can be continuously displayed at the digital display component of the brew assist scale while the changing weight of the water is continuously updated and also displayed at the digital display component. In addition, the processor can be further configured to perform all steps automatically without user input after the weight of the ground coffee is detected.

In still further embodiments of the present disclosure, various methods of preparing pour over coffee are provided. Pertinent process steps can include detecting the weight of ground coffee, determining a water target rate, detecting the water target weight being reached, and providing an output when the water target weight is reached. In various arrangements, each of these process steps can be performed automatically. Detecting the ground coffee weight can be based on ground coffee placed atop a brew assist scale. Determining the water target weight can be based on the detected ground coffee weight and a water ratio setting. Detecting the water target weight being reached can be done while water is being poured over the ground coffee atop the brew assist scale. The output can be provided to a user when the water target weight is reached while the water is being poured.

In various detailed embodiments, the method can be automatically performed by a brew assist scale while the user manually performs a pour over coffee preparation process. In some arrangements, some or all steps can be performed without user input after the weight of the ground coffee is detected. Additional process steps can include providing automatically by the brew assist scale output to the user on a display component of the brew assist scale reflecting the determined water target weight, detecting automatically by the brew assist scale the changing weight of the water poured over the ground coffee as the water is being poured over the ground coffee, and providing automatically by the brew assist scale output to the user on the display component reflecting the changing weight of the water. Alternatively, or in addition, further process steps can include accepting automatically by the brew assist scale a user input regarding a timer, providing automatically by the brew assist scale a timer output at a display component of the brew assist scale regarding a dynamically changing timer, and starting automatically by the brew assist scale the dynamically changing timer based on a user input or based on the detection of water weight first being added.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed systems, apparatuses, features, and methods for brew assist scales. These drawings in no way limit any changes in form and detail that may be made to the disclosure by one skilled in the art without departing from the spirit and scope of the disclosure.

FIG. 1 illustrates in front perspective view an example brew assist scale according to one embodiment of the present disclosure.

FIG. 2 illustrates in front perspective view an example brewing system including the brew assist scale of FIG. 1 according to one embodiment of the present disclosure.

FIG. 3 illustrates a flowchart of an example summary method of preparing pour over coffee according to one embodiment of the present disclosure.

FIG. 4A illustrates in side elevation view the brew assist scale of FIG. 1 according to one embodiment of the present disclosure.

FIG. 4B illustrates in obverse side elevation view the brew assist scale of FIG. 1 according to one embodiment of the present disclosure.

FIG. 4C illustrates in rear elevation view the brew assist scale of FIG. 1 according to one embodiment of the present disclosure.

FIG. 4D illustrates in front elevation view the brew assist scale of FIG. 1 according to one embodiment of the present disclosure.

FIG. 4E illustrates in top plan view the brew assist scale of FIG. 1 according to one embodiment of the present disclosure.

FIG. 5A illustrates in front perspective view the brewing system of FIG. 2 with the brew assist scale powered on according to one embodiment of the present disclosure.

FIG. 5B illustrates in front perspective view the brewing system of FIG. 2 as coffee grounds are added according to one embodiment of the present disclosure.

FIG. 5C illustrates in front perspective view the brewing system of FIG. 2 with a water target displayed according to one embodiment of the present disclosure.

FIG. 5D illustrates in front perspective view the brewing system of FIG. 2 with water being poured over according to one embodiment of the present disclosure.

FIG. 6A illustrates a brew assist scale display for a weight only mode of operation according to one embodiment of the present disclosure.

FIG. 6B illustrates a brew assist scale display for a weight and timer mode of operation according to one embodiment of the present disclosure.

FIG. 6C illustrates a brew assist scale display for a calculator, weight, and timer mode of operation according to one embodiment of the present disclosure.

FIGS. 7A-7F illustrate a progression of brew assist scale displays in a dynamic mode of operation for an ongoing pour over coffee preparation process according to one embodiment of the present disclosure.

FIG. 8 illustrates a flowchart of an example detailed method of preparing pour over coffee according to one embodiment of the present disclosure.

FIG. 9 illustrates a schematic diagram of electronic components for a brew assist scale according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to systems, apparatuses, features, and methods for the assisted preparation of food and beverages. In particular, the disclosed systems, apparatuses, features, and methods provide for the precise weighing of a solid or powdered component and a fluid component for the manual preparation of a beverage therefrom. In various embodiments, a brew assist scale can include a weighing component, user inputs, and a display to assist a user in the manual preparation of pour over coffee in an easy, fast, and precise manner according to the particular recipes or preferences of the user.

Although the various embodiments disclosed herein focus on brew assist scales configured to assist with brewing pour over coffee for purposes of simplicity in illustration, it will be readily appreciated that the disclosed systems, apparatuses, and features can similarly be used for any other kind of beverage preparation involving weighted recipes. For example, the disclosed systems, apparatuses and features can be used for preparing other forms of coffees, various teas, and other mixed beverages involving different weighted ingredients. Other applications and extrapolations of the disclosed embodiments are also possible.

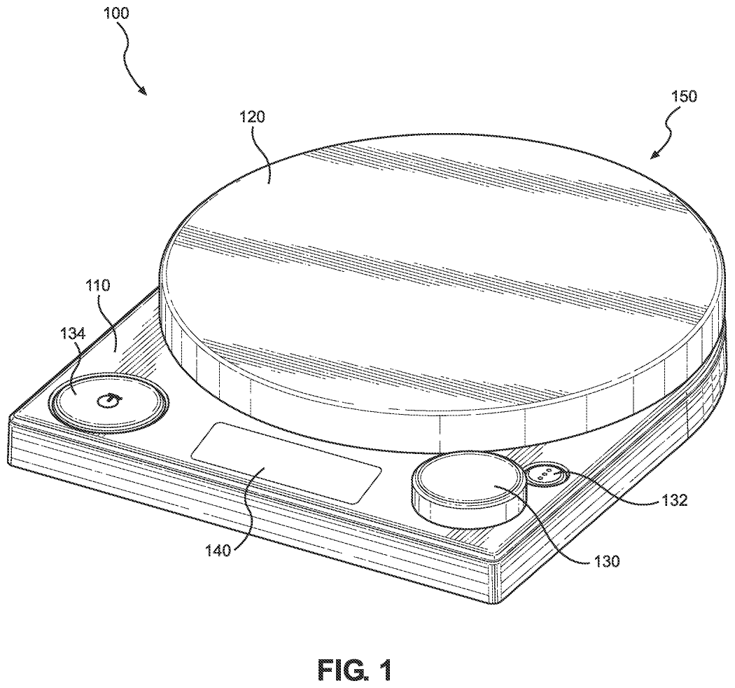

Referring first to FIG. 1, an example brew assist scale is shown in front perspective view. Brew assist scale 100 can include a main body 110, a weigh pan 120, one or more user input components 130, 132, 134, a display component 140, and a charging port 150, among other possible components. Main body 110 can have an outer housing and one or more internal components contained therein, such as a processor, battery, load detection unit, and other items. Various items can be disposed about the outer housing of main body 110, and these can include input components 130, 132, 134, display component 140, and charging port 150, for example.

Weigh pan 120 can be coupled to the main body 110, such as atop the main body, and can be configured to support beverage components to be weighed thereupon. In various arrangements, weigh pan 120 can define a substantially flat upper surface such the weigh pan can readily accommodate oversized containers and other components. Weights experienced atop weigh pan 120 can be detected and measured by a load detection unit located inside the main body 110 and coupled to an internal processor, arrangements for which will be readily understood by those of skill in the art.

User input components can include a power and tare button 130, a mode select button 132, and a timer control button 134, among other possible input components. In some arrangements, the power and tare button 130 can include a vertically actuated push button input component as well as a rotational dial input component. When actuated as a pressed button, power and tare button 130 can be used to power the brew assist scale 100 on or off, to tare the weight reading for the weight detected atop weigh pan 120. When used as a rotational dial, power and tare button 130 can be used to adjust settings or user preferences, such as, for example, to adjust a preferred coffee grounds to water weight ratio or to toggle between different unit measurements.

Display component 140 can be a recessed digital display disposed at an upper flat surface along the outer housing at the front of main body 110. This display component 140 can be configured to display outputs regarding various informational items, such as weights detected and measured on the weigh pan 120, coffee to water ratio selections, target water weights, dynamically changing weights measured by the weigh pan, target water weights being reached statuses, and dynamically changing timers, for example. Other informational items can also be presented at display component 140, as set forth in greater detail below.

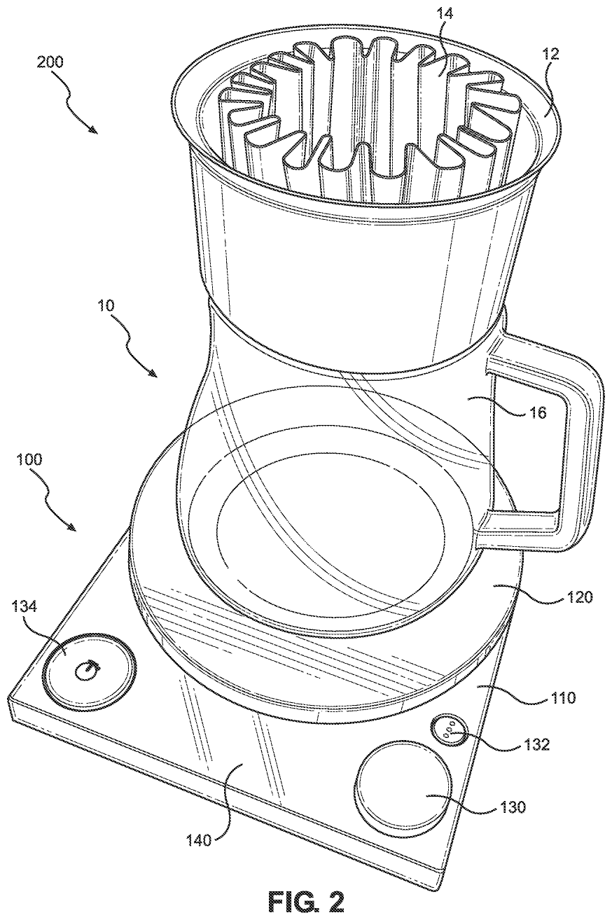

Continuing with FIG. 2, an example brewing system including the brew assist scale of FIG. 1 is shown in front perspective view. Brewing system 200 can include a brew assist scale 100 as well as various pour over brewing components 10 that can be placed atop the brew assist scale. Again, brew assist scale 100 can include a main body 110, a weigh pan 120, one or more user input components 130, 132, 134, and a display component 140. Pour over brewing components 10 can include an upper collection unit 12 configured to hold coffee grounds and water poured thereover, a filter 14 placed into the upper collection unit, and a catch 16 or pot configured to capture water filtered through the water collection unit and coffee. Other components or alternatives may be used in addition to or in place of the pour over brewing components 10 shown, as will be readily appreciated.

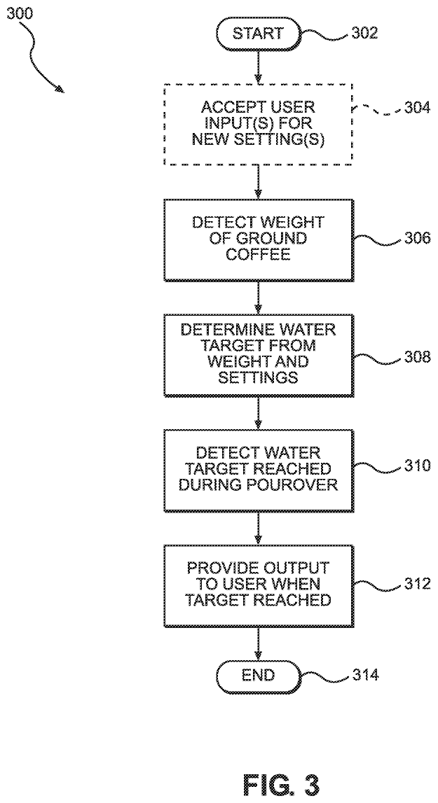

Turning next to FIG. 3, a flowchart of an example summary method 300 of preparing pour over coffee is provided. Summary method 300 can represent a broad overview of steps performed by an assisting device or system in association with a manual pour over brewing process conducted by a user, and it will be understood that various other steps, features, and details of such a broad overview method are not provided here for purposes of simplicity. Some or all of the steps in summary method 300 can be performed automatically by the assisting device or system, such as a brew assist scale as disclosed herein, and it will be understood that other steps and functions of an overall method of preparing pour over coffee can be conducted manually by a user who is using the assisting device or system.

After a start step 302, a first optional process step 304 can involve accepting one or more user inputs for one or more new settings on a brew assist scale or other suitable assisting device or system. Optional process step 304 can be automatically performed by the assisting device or system. User inputs can be provided by way of one or more user input components on the brew assist scale or other suitable assisting device or system as set forth herein, and possible settings can include a desired coffee to water weight ratio setting, a desired timer setting, and/or desired units of measurement settings, among other possible new settings. In the event that no user inputs are provided, then optional process step 304 can be skipped and the device or system can use default settings or the most recently entered settings for any relevant values.

At a following process step 306, the weight of ground coffee to be used in the overall method of preparing pour over coffee can be detected. Process step 306 can be automatically performed by the assisting device or system. This can involve detecting the weight of the ground coffee by the brew assist scale or other relevant device or system, such as where the ground coffee is placed atop the brew assist scale or other relevant device. A taring operation to account for any other weights on the scale or device may also be included.

At the next process step 308, a water target weight can be determined based on the detected ground coffee weight and a coffee to water weight ratio setting. Process step 308 can be automatically performed by the assisting device or system. Such a coffee to water weight ratio setting can be one that has been selected by the user and input into the assisting device or system, or this setting can be a default or previously used setting. Determination of the water target weight can be done by the assisting device or system multiplying the detected ground coffee weight by a factor reflecting the weight ratio setting. For example, where the detected ground coffee weight is 20 grams and the weight ratio setting is 16-1, then the water target weight can be determined to be 320 grams.

At a subsequent process step 310, the water target weight being reached while water is being poured over the ground coffee can be detected. Process step 310 can be automatically performed by the assisting device or system. This can involve the assisting device or system detecting and measuring the increasing weight of the water as it is being poured over the ground coffee by the user while the coffee and water remain atop the scale, and then detecting when the increasing weight of the water reaches the water target weight.

At a following process step 312, an output can be provided to the user when the water target weight is reached. Process step 312 can be automatically performed by the assisting device or system. This can involve providing the output on a visual display of the brew assist scale or other assisting device or system. This output can include, for example, the exact weight of the water, as well as an additional visual indicator signifying that the water target weight has been reached. Other outputs are also possible. The method can then end at end step 314.

For the foregoing summary method 300, it will be appreciated that not all process steps are necessary, and that other process steps and details may be added. Furthermore, the order of steps may be altered in some cases, and some steps may be performed simultaneously. For example, steps 310 and 312 may be performed simultaneously in some arrangements. Other possible process steps and details are provided in further examples below, and variations and extrapolations of method 300 will also be readily appreciated by those of skill in the art.

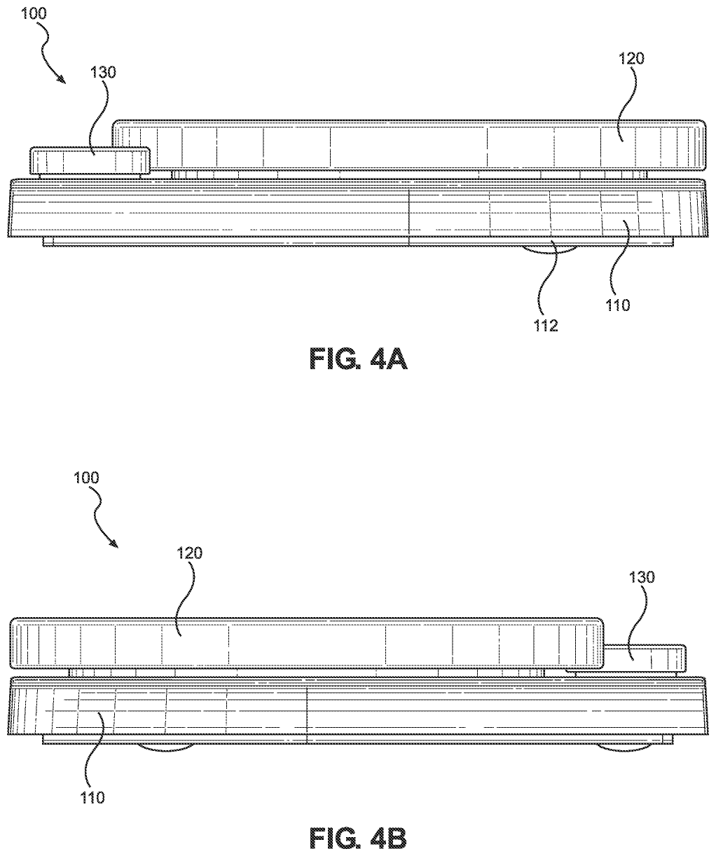

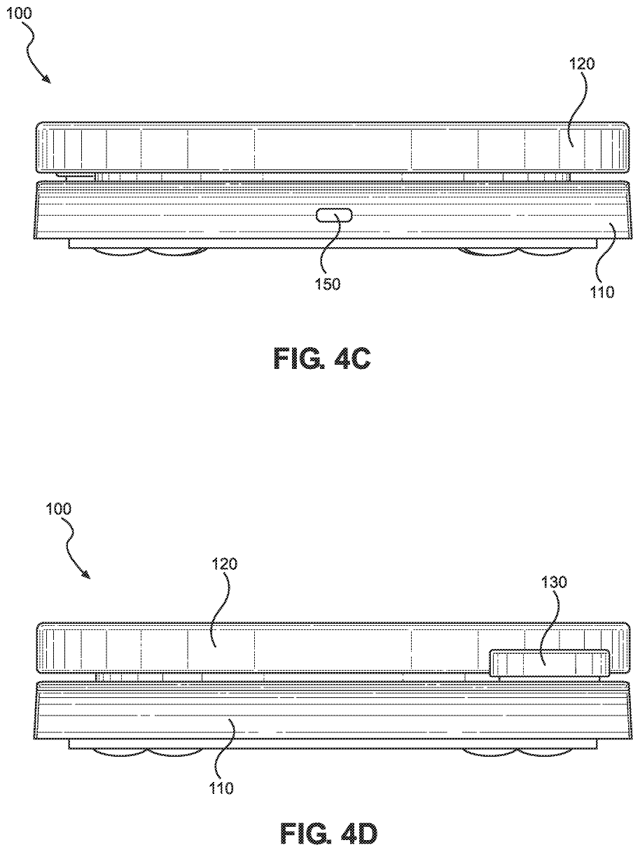

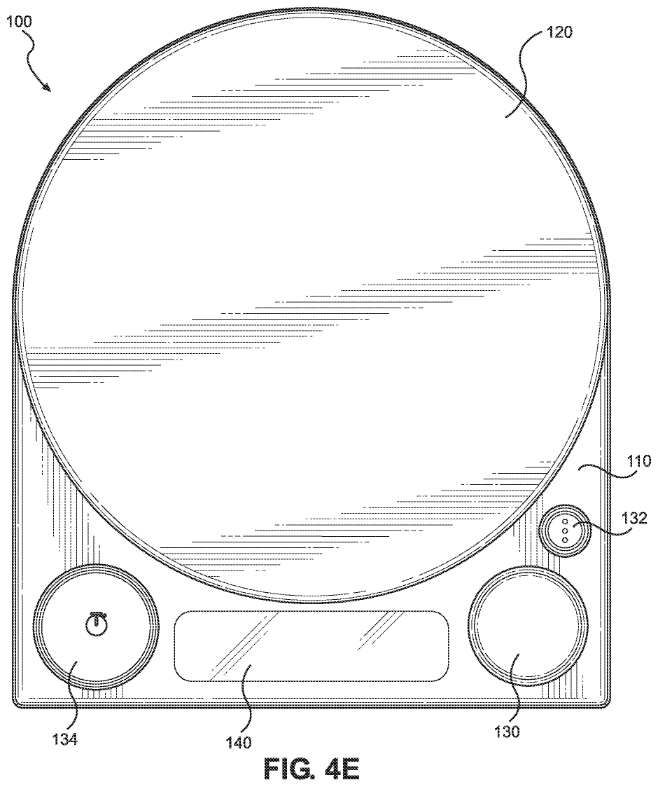

FIGS. 4A through 4E illustrate the brew assist scale of FIG. 1 in side elevation, obverse side elevation, rear elevation, front elevation, and top plan views respectively. These figures simply present varying views of the components disclosed and described in the brew assist scale 100 shown in FIG. 1. In addition to previously noted components main body 110, weigh pan 120, user input components 130, 132, 134, display component 140, and charging port 150, brew assist scale 100 can also include one or more feet 112 or other stabilizing components located along the bottom surface of the main body, among other possible components and items.

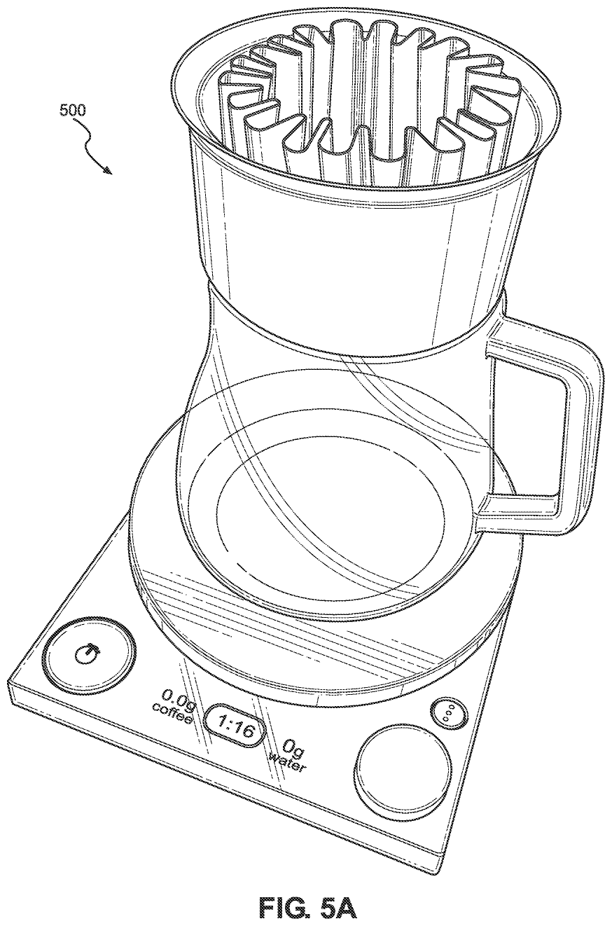

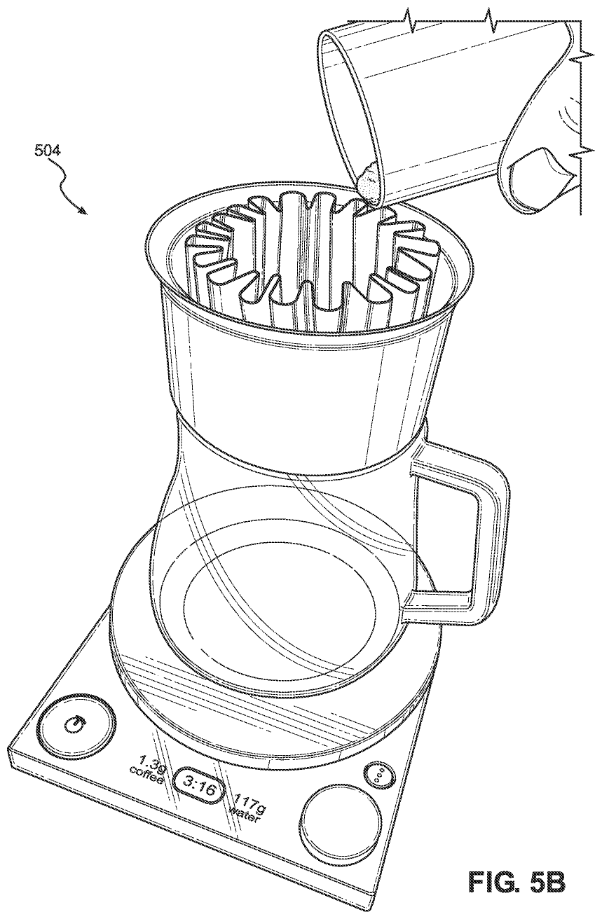

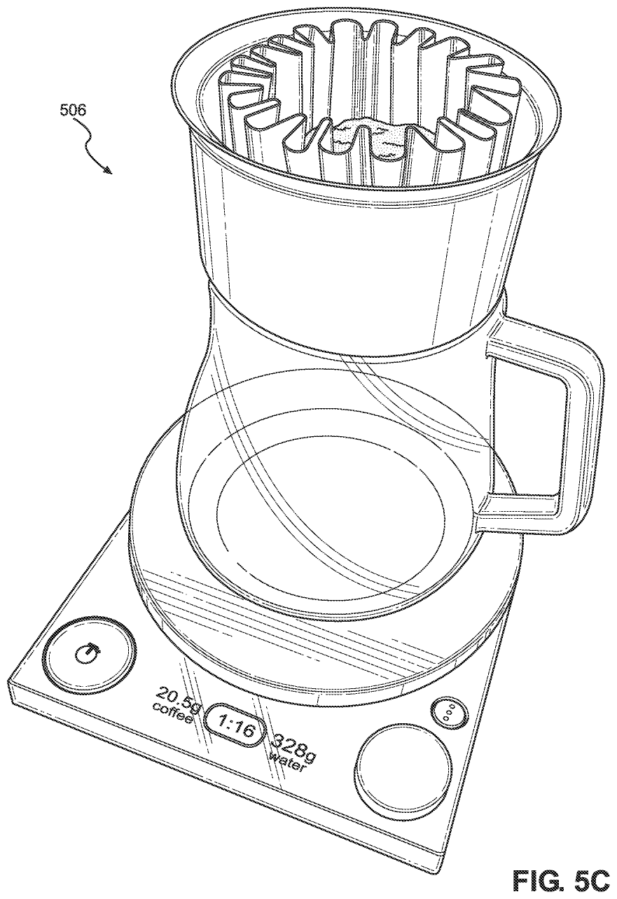

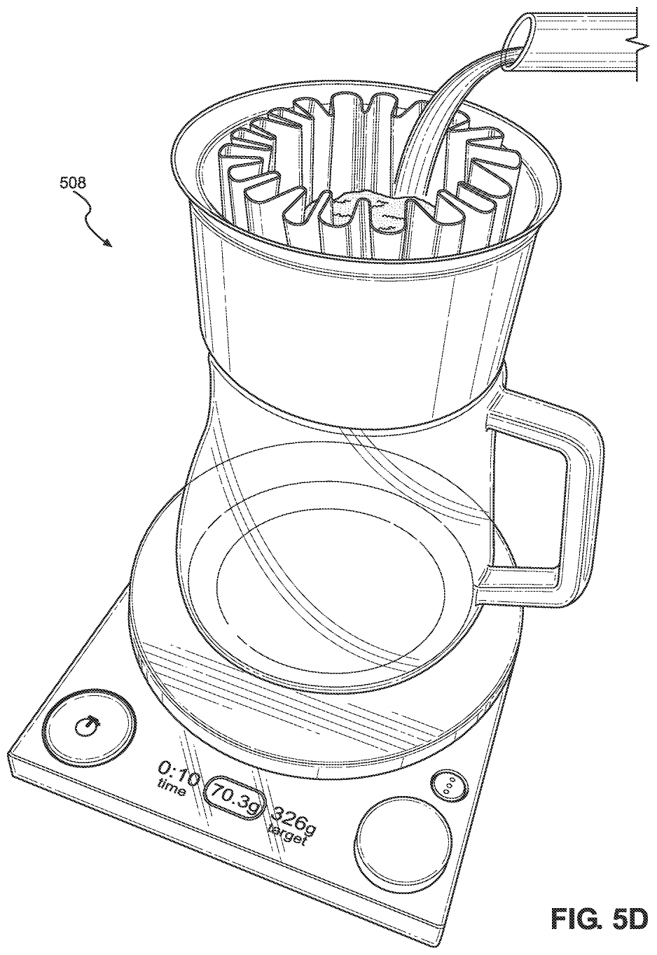

Transitioning now to FIGS. 5A-5D various stages of a pour over coffee preparation process are shown in front perspective view. In each of stages 500, 502, 504, and 506, a brewing system 200 can include various brewing components placed atop the weigh pan of a brew assist scale 100, and the brew assist scale can be powered on to provide a visual display at its display component located along a top surface of its main body. At stage 500, the brewing components can be empty except for a filter and the brew assist scale 100 can be tared to zero out its current weight reading. At stage 502, ground coffee can be dynamically added into the filter atop the brewing components on the brew assist scale 100, and the current weight reading displayed on the scale can dynamically increase to reflect the weight of the ground coffee being added. A ground coffee to water weight ratio setting and dynamically increasing target water weight can also be displayed on the brew assist scale 100 at this stage 502. At stage 504, all of the desired ground coffee can be situated into the filter and a final ground coffee weight reading, the weight ratio setting, and a final target water weight can be displayed on the brew assist scale 100. At stage 506, water can be dynamically poured over the coffee grounds in the filter, and a water weight reading on the brew assist scale 100 can dynamically increase to reflect the weight of the water being added. A dynamically changing timer and the static target water weight can also be displayed on the brew assist scale 100 at this stage 506.

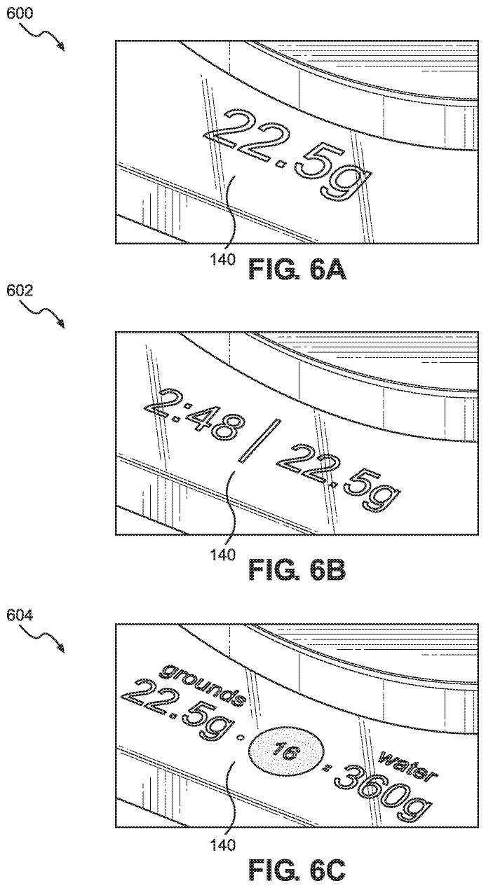

FIG. 6A illustrates a brew assist scale display 140 for a weight only mode of operation. As shown, weight only mode of operation 600 can involve displaying only a weight measured on the weigh pan of an associated brew assist scale. The displayed weight can be in any of a variety of units of measurement as selected by a user, such as grams for example, and this displayed weight can be dynamically updated as the weight on the weigh pan changes.

FIG. 6B illustrates a brew assist scale display 140 for a weight and timer mode of operation. As shown, weight and timer mode of operation 602 can involve displaying a timer amount and also a weight measured on the weigh pan of an associated brew assist scale as set forth in mode 600 above. The displayed timer amount can be a statically chosen amount, and can also be a dynamically increasing or decreasing timer as may be selected by a user.

FIG. 6C illustrates a brew assist scale display 140 for a calculator, weight, and timer mode of operation. As shown, calculator, weight, and timer mode of operation 604 can involve displaying a ratio setting and a calculated water weight target, and also a timer amount as set forth in mode 602 above and a weight measured on the weigh pan of an associated brew assist scale as set forth in mode 600 above. The displayed ratio setting may be selected by a user and the calculated water weight target can be calculated based on the weight measured on the associated weigh pan and the displayed ratio setting. The calculated water weight target can be dynamically changed corresponding to any dynamic change in the weight measured.

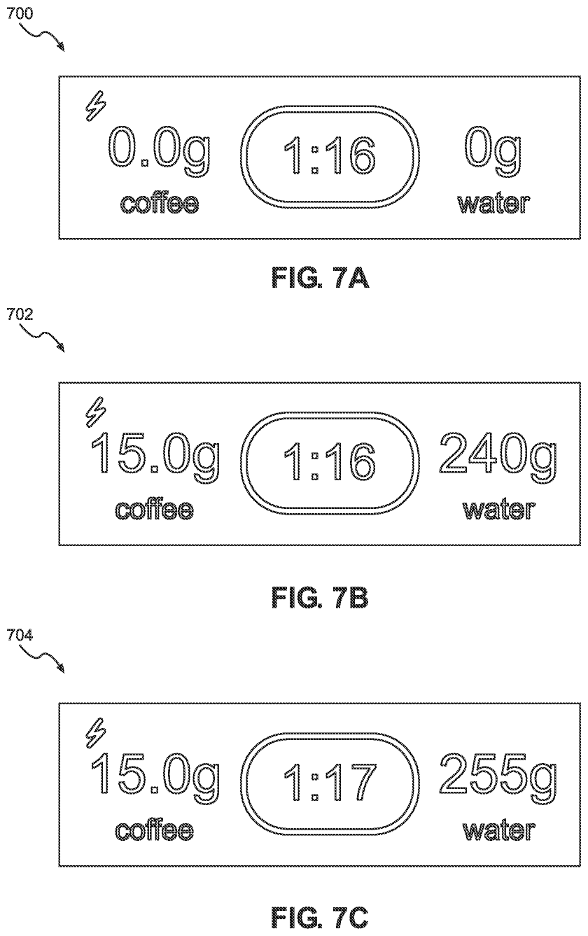

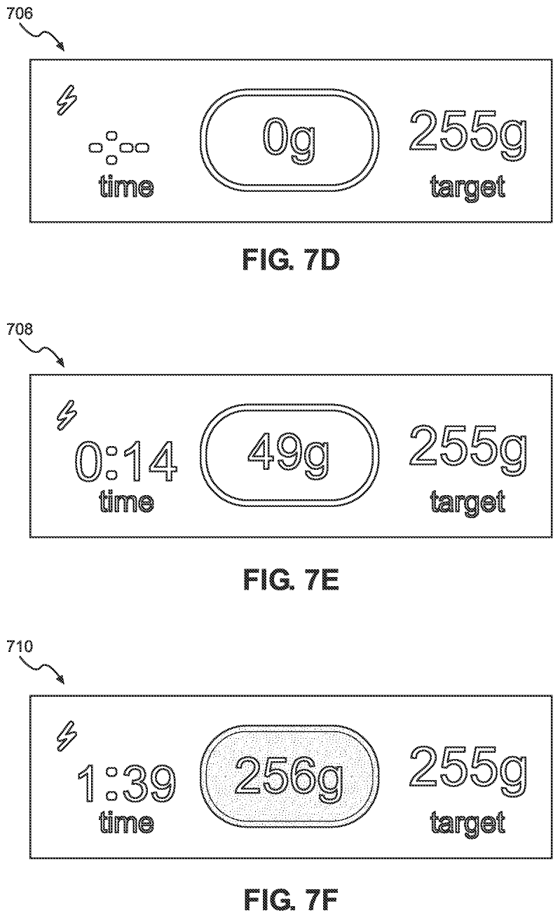

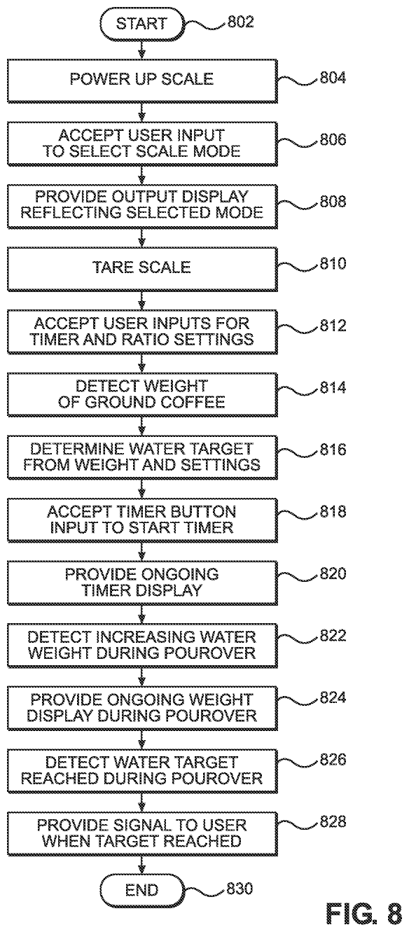

Continuing with FIGS. 7A through 7F, a progression of example brew assist scale displays are shown in a dynamic mode of operation for an ongoing pour over coffee preparation process. These provided scale assist displays can reflect various stages of an overall pour over coffee preparation process, such that manual steps performed by a user can be assisted with various displayed elements and alerts. For example, a user can be allowed to change the setting for the coffee to water weight ratio before or after ground coffee weight is detected by the brew assist scale or other brew assist device. In such instances, the brew assist scale display can then automatically change its display of the selected weight ratio, and also its display of the water target weight (in the event that ground coffee weight is currently detected and measured by the brew assist scale) without any further input or intervention by the user.

Starting with FIG. 7A, a brew assist scale display 700 is depicted for a dynamic mode of operation showing no weight of coffee detected or measured on the brew assist scale, a 1:16 coffee to water selected weight ratio, and no water target weight, which corresponds to the no weight of coffee detected on the scale. In various arrangements, a variety of weight ratios can be selected by a user and/or provided as settings within the brew assist scale. For example, weight ratios can vary from 1:2.5 to 1:20 or more. In various situations, a 1:8 weight ratio may be preferred for cold pour over brewing, a 1:14 weight ratio may be preferred for French press use, and 1:16 to 1:20 weight ratios may be preferred for typical hot pour over brewing.

FIG. 7B illustrates the brew assist scale display from FIG. 7A as being progressed to display 702 showing 15.0 grams of coffee detected, the same 1:16 coffee to water weight ratio, and a calculated water target weight of 240 grams, which corresponds to the coffee weight detected and the selected weight ratio. The 15.0 grams of coffee can be that which is detected and measured in the weigh pan of the brew assist scale or other suitable brew assist device, and it will be appreciated that more or less coffee can be used in a given situation. In the event that more coffee is added or some of the existing coffee is removed, then the display 702 will show the changed amount of measured coffee weight and a new calculated water target weight automatically without any further input or action by the user.

FIG. 7C illustrates the brew assist scale display from FIG. 7B as being progressed to display 704 showing 15.0 grams of coffee detected, a newly selected 1:17 coffee to water weight ratio, and a calculated water target weight of 255 grams, which corresponds to the coffee weight detected and the newly selected weight ratio. This reflects the ability of the user to select a new weight ratio after coffee weight on the scale has been measured, and the brew assist scale can automatically calculate and display a new water target weight without dynamically without requiring any further input or action by the user.

FIG. 7D illustrates the brew assist scale display from FIG. 7C as being progressed to display 706 showing a timer at no time elapsed, a currently measured 0 grams of water, and the previously calculated water target weight of 255 grams, which corresponds to the previously detected coffee weight of 15 grams and the previously selected 1:17 weight ratio. This display can reflect the detection or acceptance of an input by the user that the desired final amount of coffee has been placed onto the brew assist scale, and that a timer function can be initiated. The timer can be started based on a manual input by the user or based on the brew assist scale detecting added weight onto the scale. Such a detected increase in weight can correspond to a water pour over being initiated by the user, whereupon the system then starts the timer.

FIG. 7E illustrates the brew assist scale display from FIG. 7D as being progressed to display 708 showing the timer at 14 seconds elapsed, a currently measured 49 grams of water, and the same calculated water target weight of 255 grams, which corresponds to the previously detected coffee weight and the previously selected 1:17 weight ratio. Display 708 can reflect dynamic changes both to the displayed timer and the displayed water weight measured as water is continuously poured over the coffee grounds by the user during the overall brew process.

FIG. 7F illustrates the brew assist scale display from FIG. 7E as being progressed to display 710 showing the timer at one minute and 39 seconds elapsed, a currently measured 256 grams of water, and the same calculated water target weight of 255 grams, which corresponds to the previously detected coffee weight and the previously selected 1:17 weight ratio. Because the water target weight has been reached, the pill shaped display element showing the currently measured 256 grams of water has been lit up and its text inverted from white to black to reflect that the current water weight and indicate that the water target weight has been reached and that the water pour over can be halted.

It will be readily appreciated that other coffee weights, other weight ratios, and other timer amounts and rates of pouring can be selected and/or observed, and that the dynamic display process can vary to reflect the variability of these different parameters. Furthermore, one or more additional and/or alternative indicators can be provided to reflect that the water target rate has been reached. For example, the entire display can be lit up with the text inverted from white to black in some arrangements. In some arrangements, one or more audible alerts can be provided. For example, the brew assist scale can emit a beeping sound or pattern to provide additional indication that the target water weight has been reached. Additional beeping or sound patterns can also be provided during the process of dynamically adding water, such as sound with an increasing or decreasing pitch during the pour over process. In such arrangements, one or more speakers, piezo units, or other sound output components can be included within the brew assist scale or assisting device, such sound output components being coupled to the processor.

FIG. 8 illustrates a flowchart of an example detailed method 800 of preparing pour over coffee. As in the case of summary method 300 above, detailed method 800 can represent steps performed by an assisting device or system in association with a manual pour over brewing process conducted by a user, and it will be understood that various other steps, features, and details of such a method are not provided here for purposes of simplicity. Some or all of the steps in detailed method 800 can be performed automatically by the assisting device or system, such as a brew assist scale as disclosed herein, and it will be understood that other steps and functions of an overall method of preparing pour over coffee can be conducted manually by a user who is using the assisting device or system. Furthermore, it will be understood that not all steps of detailed method 800 need to be performed in a given situation.

After a start step 802, a first process step 804 can involve powering up the brew assist scale or other suitable assisting device or system. Process step 804 can be automatically performed by the assisting device or system, and this can be done in response to a user input to turn on the device, by way of an automated timer or other scheduled event, or through any other suitable way to initiate device power up.

At a following process step 806, a user input can be accepted regarding the selection of a scale mode or other operational mode of the assisting device or system. Process step 806 can be automatically performed by the assisting device or system, and this can be done in response to a user input to select a scale mode. Such a scale mode can be, for example, a weight only mode of operation, a weight and timer mode of operation, or a calculator, weight, and timer mode of operation, among other possible operational modes. In the event that no user input is provided, then the assisting device or system can use a default mode setting or the most recently entered mode setting.

At a subsequent process step 808, an output display can be provided to reflect the selected mode of operation. Process step 808 can be automatically performed by the assisting device or system. This can involve providing the output display on a display component of the brew assist scale or other suitable assisting device or system. In the event that a mode of operation was not selected by the user, then a default or last previously used mode of operation can be displayed.

At the next process step 810, the scale or other assisting device can be tared. Process step 810 can be automatically performed by the assisting device or system. This can involve accepting a taring input from a user and then automatically taring the weight reading of the scale in response to the taring input from the user.

At a following process step 812, one or more user inputs can be accepted. Process step 812 can be automatically performed by the assisting device or system. Again, user inputs can be provided by way of one or more user input components on the brew assist scale or other suitable assisting device or system as set forth herein, and possible settings can include a desired coffee to water weight ratio setting, a desired timer setting, and/or desired units of measurement settings, among other possible new settings. In the event that no user inputs are provided, then process step 812 can be skipped and the device or system can use default settings or the most recently entered settings for any relevant values.

At a subsequent process step 814, the weight of ground coffee to be used in the overall method of preparing pour over coffee can be detected. Process step 814 can be automatically performed by the assisting device or system. Again, this can involve detecting or measuring the weight of the ground coffee by the brew assist scale or other device or system, such as where the ground coffee is placed atop the brew assist scale or other relevant device.

At the next process step 816, a water target weight can be determined based on the detected ground coffee weight and a coffee to water weight ratio setting. Process step 816 can be automatically performed by the assisting device or system. Again, the coffee to water weight ratio setting can be one that has been selected by the user and input into the assisting device or system, or this setting can be a default or previously used setting. Determination of the water target weight can be done by the assisting device or system multiplying the detected ground coffee weight by a factor reflecting the weight ratio setting, as noted above.

At a following process step 818, a user input at a timer button to start the timer can be accepted. Process step 818 can be automatically performed by the assisting device or system. This can involve accepting the user input, which can be a button push or hold, for example.

At a subsequent process step 820, an ongoing timer display can be provided. Process step 820 can be automatically performed by the assisting device or system. This can involve providing a display of a dynamically changing timer during the water pour over process. Such a dynamically changing timer can reflect a total time elapsed counting from 0 seconds, or can reflect a time countdown to 0 seconds from an initially set timer amount. In some arrangements, one or more additional display elements, alerts, or sounds can be provided to the user when a countdown timer reaches 0 seconds. This can be in addition to any alert provided to the user when the target water weight is reached.

At the next process step 822, increasing water weight during the water pour over process can be detected and measured. Process step 822 can be automatically performed by the assisting device or system. This can involve dynamically updating the detected and measured weight of the water added atop the coffee grounds during the pour over process.

At a following process step 824, an output can be provided to the user reflecting the measured water weight during the pour over. Process step 824 can be automatically performed by the assisting device or system. This can involve providing a dynamically updated display output to the user as the water weight increases during the addition of water.

At a subsequent process step 826, the water target weight being reached while water is being poured over the ground coffee can be detected. Process step 826 can be automatically performed by the assisting device or system. This can involve the assisting device or system detecting and measuring the increasing weight of the water as it is being poured over the ground coffee by the user while the coffee and water remain atop the scale, and then detecting when the increasing weight of the water reaches the water target weight.

At the next process step 828, an output can be provided to the user when the water target weight is reached. Process step 828 can be automatically performed by the assisting device or system. This can involve providing the output on a visual display of the brew assist scale or other assisting device or system. This output can include, for example, the exact weight of the water, as well as an additional visual indicator signifying that the water target weight has been reached. As noted above, this can involve lighting up a certain region on the visual display, lighting up the entire display, inverting text on the lit up portions of the display, and/or providing one or more sounds or other audio alerts. Other outputs are also possible. The method can then end at end step 830.

For the foregoing detailed method 800, it will be appreciated that not all process steps are necessary, and that other process steps and details may be added. Furthermore, the order of steps may be altered in some cases, and some steps may be performed simultaneously. For example, all or part of step 812 may be performed after step 814 or step 816, with one or both of these steps possibly being repeated as a result. As another example, steps 820-824 may be performed simultaneously in some arrangements. Other variations and extrapolations of detailed method 800 will also be readily appreciated by those of skill in the art.

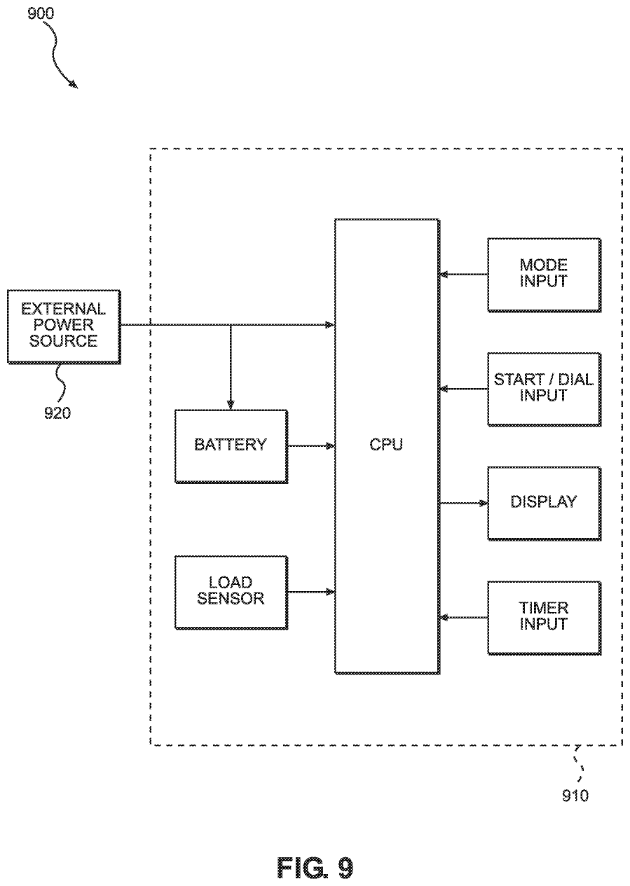

Finally, FIG. 9 illustrates a schematic diagram of electronic components for a brew assist scale. Electronic component arrangement 900 can generally include multiple internal components 910 contained within or located about an outer housing of the scale itself, as well as one or more external components 920 located outside of the scale. Internal components can include user input components or devices, such as a mode button input, a start button and dial input, and a timer input. Internal components can also include a load sensor configured to detect a weight load, a display to provide outputs to a user, and a battery or other internal power source. Each of these internal components 910 can be electrically and/or communicatively coupled to a CPU, which can include one or more processors, memory units, and/or other circuitry items. External components can include an external power source and/or one or more additional outside items, such as, for example, a communication network, additional memory storage, outside user input components, and/or outside display components, for example. Other components, items, and features may be included for a brew assist scale or other suitable smart brew assist device or system, as will be appreciated by those of skill in the art.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. An apparatus configured to assist with beverage preparation, the apparatus comprising:
a main body having an outer housing and one or more internal components contained therein;
a weigh pan coupled to the main body and configured to support beverage components to be weighed thereupon;
one or more user input components disposed at the outer housing, wherein the one or more user input components are configured to accept user inputs regarding desired settings for beverage preparation;
a display component disposed at the outer housing, wherein the display component is configured to display outputs regarding weights detected on the weigh pan; and
a processor disposed within the main body and coupled to the one or more user inputs and the display component, wherein the processor is configured to facilitate:
detecting automatically the weight of ground coffee placed atop the weigh pan,
determining automatically a water target weight based on the detected ground coffee weight and a water ratio setting,
detecting automatically the water target weight being reached while water is being poured over the ground coffee, and
providing automatically output to a user when the water target weight is reached.

2. The apparatus of claim 1, wherein the one or more user input components include a power and tare button, a mode select button, and a timer control button.

3. The apparatus of claim 2, wherein the power and tare button includes a dial component configured to accept user input for different settings.

4. The apparatus of claim 3, wherein the different settings include settings for measurement units and water to coffee ratios.

5. The apparatus of claim 1, further including:
a battery disposed within the main body and coupled to the processor; and
a charging port disposed at the outer housing and coupled to the battery, wherein the charging port is configured to facilitate charging the battery from an external power source.

6. The apparatus of claim 1, wherein the processor is further configured to facilitate:
providing automatically output to the user on the display component reflecting the determined water target weight,
detecting automatically the changing weight of the water poured over the ground coffee as the water is being poured over the ground coffee, and
providing automatically output to the user on the display component reflecting the changing weight of the water.

7. The apparatus of claim 6, wherein the processor is further configured to detect the changing weight of the water and provide output reflecting the changing weight of the water dynamically and continuously as the water is being poured over the ground coffee.

8. The apparatus of claim 7, wherein the processor is further configured to perform all steps automatically without user input after the weight of the ground coffee is detected.

9. The apparatus of claim 1, wherein the output when the water target weight is reached is automatically provided on the display component.

10. The apparatus of claim 1, wherein the processor is further configured to facilitate:
accepting automatically a user input at one of the user input components regarding a timer, and
providing automatically a timer output at the display component regarding a dynamically changing timer.

11. The apparatus of claim 10, wherein the processor is further configured to start the dynamically changing timer based on a user input or based on the detection of water weight first being added.

12. A brew assist scale configured to assist with the manual preparation of pour over coffee by a user, the brew assist scale comprising:
a main body having an outer housing and one or more internal components contained therein;
a weigh pan coupled to the main body and configured to support pour over coffee brewing components as well as coffee and water to be weighed thereupon;
a power and tare button disposed at the outer housing and configured to accept user inputs regarding powering the brew assist scale and taring a weight detected on the weigh pan;
a mode select button disposed at the outer housing and configured to accept user input regarding a mode of operation of the brew assist scale;
a timer control button disposed at the outer housing and configured to accept user input regarding the operation of a timer associated with a manual pour over coffee preparation process;
a digital display component disposed at the outer housing, wherein the digital display component is configured to display outputs regarding mode selection, timer operation, and weights detected on the weigh pan during the manual pour over coffee preparation process; and
a processor disposed within the main body and coupled to the power and tare button, the mode select button, the timer control button, and the display component, wherein the processor is configured to facilitate:
detecting automatically the weight of ground coffee placed atop the weigh pan,
determining automatically a water target weight based on the detected ground coffee weight and a water to coffee ratio setting,
providing automatically output to the user on the digital display component reflecting the determined water target weight,
detecting automatically the changing weight of the water poured over the ground coffee as the water is being poured over the ground coffee during the manual pour over coffee preparation process,
providing automatically output to the user on the digital display component reflecting the changing weight of the water,
detecting automatically the water target weight being reached while water is being poured over the ground coffee during the manual pour over coffee preparation process, and
providing automatically output to the user on the digital display component when the water target weight is reached.

13. The brew assist scale of claim 12, wherein the determined water target weight is continuously displayed at the digital display component while the changing weight of the water is continuously updated and also displayed at the digital display component.

14. The brew assist scale of claim 13, wherein the processor is further configured to perform all steps automatically without user input after the weight of the ground coffee is detected.

15. A method of preparing pour over coffee, the method comprising:
detecting automatically by a brew assist scale the weight of ground coffee placed atop the brew assist scale;
determining automatically by the brew assist scale a water target weight based on the detected ground coffee weight and a water ratio setting;
detecting automatically by the brew assist scale the water target weight being reached while water is being poured over the ground coffee atop the brew assist scale; and
providing automatically by the brew assist scale output to a user when the water target weight is reached.

16. The method of claim 15, wherein the method is performed by a brew assist scale while the user manually performs a pour over coffee preparation process.

17. The method of claim 15, wherein all steps are performed without user input after the weight of the ground coffee is detected.

18. The method of claim 15, further comprising the steps of:
providing automatically by the brew assist scale output to the user on a display component of the brew assist scale reflecting the determined water target weight;
detecting automatically by the brew assist scale the changing weight of the water poured over the ground coffee as the water is being poured over the ground coffee; and
providing automatically by the brew assist scale output to the user on the display component reflecting the changing weight of the water.

19. The method of claim 15, further comprising the steps of:
accepting automatically by the brew assist scale a user input regarding a timer; and
providing automatically by the brew assist scale a timer output at a display component of the brew assist scale regarding a dynamically changing timer.

20. The method of claim 19, further comprising the step of:
starting automatically by the brew assist scale the dynamically changing timer based on a user input or based on the detection of water weight first being added.
